(19) United States
(12) Patent Application Publication
(10) Pub. No.: US 2025/0135683 A1
(43) Pub. Date: May 1, 2025

(54) Small-Sized Wire Saw Device

(71) Applicant: EGUN CO., LTD., Gwangju-si (KR)

(72) Inventors: Sung Jun LEE, Gwangju-si (KR); Chae Mun LEE, Seongnam-si (KR)

(21) Appl. No.: 18/834,418

(22) PCT Filed: Feb. 3, 2022
(86) PCT No.: PCT/KR2022/001721

§ 371 Date: Jul. 30, 2024

(51) Int. Cl. B28D 1/08; B28D 7/00

(52) U.S. Cl. CPC B28D 1/088; B28D 7/005

(57) ABSTRACT

A small-sized wire saw device may comprise: a stand portion which comprises a main frame formed in a bar shape elongated in back and forth directions, an exterior frame located at the front portion of the main frame, and a connecting frame connecting the main frame and the exterior frame, while an object to be cut is located in front of the small-sized wire saw device; a slider portion which modes forward or downward on the main frame; a driving power unit including a first motor attached to the upper end of the slider portion; a main wheel which is attached to one side surface of the driving power unit and is rotated by the first motor; and a second motor which is located on the other side surface of the driving power unit and supports the movement of the slider portion.

### TECHNICAL FIELD

The present invention relates to a wire saw device, and more particularly to a small-sized wire saw device.

### BACKGROUND ART

Conventional diamond wire saw devices have been used to cut a huge structure constituted by rocks, concrete, etc. Conventional diamond wire saw devices have a great volume and are expensive, and, as such, individuals have difficulty purchasing and using such a diamond wire saw device. In a work site, a situation in which a precise cutting task is required or cutting of a small concrete structure, a small rock, etc. is required may occur. In this case, the conventional diamond wire saw device as mentioned above has a problem in that the conventional diamond wire saw device exhibits degradation of work efficiency, etc. in cutting a small section of concrete, a small rock, or a small wall structure and, as such, is unsuitable for cutting tasks.

Therefore, the present invention proposes a small-sized wire saw device suitable for cutting of a small structure such as a small section of concrete, a small rock, etc.

### DISCLOSURE

### Technical Problem

It is an object of the present invention to provide a small-sized wire saw device.

### Technical Solution

In accordance with the present invention, the above and other objects can be accomplished by the provision of a small-sized wire saw device including: a stand including a main frame having a bar shape elongated forwards and rearwards in a state in which an object to be cut is disposed in front of the small-sized wire saw device, an outer frame disposed at a front portion of the main frame, and a connection frame configured to interconnect the main frame and the outer frame; a slider configured to move forwards or downwards on the main frame; a power unit including a first motor attached to an upper end of the slider; a main wheel attached to one side surface of the power unit and configured to be rotated by the first motor; and a second motor disposed at another side surface of the power unit and configured to support movement of the slider. The small-sized wire saw device may further include a reducer disposed at the other surface of the power unit between the second motor and the slider and configured to transmit power generated from the second motor to the slider. The first motor may include a pneumatic motor.

The small-sized wire saw device may further include a first hose connected to the first motor and configured to supply a coolant to the first motor, when the first motor is an electric motor, and a second hose disposed between the first motor and the main wheel and configured to outwardly discharge the supplied coolant.

The slider may include a central groove having a structure corresponding to a structure of the central rail, first protrusions each having a structure corresponding to a structure of the upper grooves, and second protrusions each having a protruding structure corresponding to a structure of the side grooves. The main frame may include a central rail formed at an upper end of the main frame to have a protruding structure, upper grooves respectively formed in a longitudinal direction at opposite sides of the central rail to have an engraving structure, and side grooves respectively formed in the longitudinal direction at opposite side surfaces of the main frame to have an engraving structure. The small-sized wire saw device may further include a controller connected to the second motor. The controller may include a first manipulator configured to control forward movement or rearward movement of the slider, and a second manipulator configured to control a speed of the slider. A vertical frame may be provided at an upper end of the front portion of the main frame, and the outer frame may be provided at a lower end of the front portion of the main frame. An upper auxiliary wheel or a lower auxiliary wheel may be provided at one side surface of the vertical frame, and a wire configured to be driven by the main wheel may contact the upper auxiliary wheel or the lower auxiliary wheel so as to be rotated.

The small-sized wire saw device may further include a bottom frame installed at an upper end of the connection frame, and auxiliary wheels respectively attached to opposite ends of the bottom frame. The small-sized wire saw device may further include an additional frame connected to a rear portion of the main frame. The slider may be configured to move forwards or downwards on the main frame and the additional frame.

### Advantageous Effects

In accordance with the present invention, the following effects are provided.

The present invention provides an effect of providing convenience to the operator through manufacture of a small-sized wire saw device.

In addition, the present invention provides an effect of easily controlling the wire saw device through movement of a wheel by a button of a controller.

Furthermore, the present invention provides an effect of achieving cutting of concrete, rock, etc. using low electric power.

### DESCRIPTION OF DRAWINGS

FIG. 1 is a view showing a configuration of a small-sized wire saw device according to an embodiment of the present invention.

FIG. 2 is a view showing a configuration of a power unit and a wheel according to an embodiment of the present invention.

FIG. 3 is a view showing a connection structure between a main frame and the power unit according to an embodiment of the present invention.

FIG. 4 is a view showing a figure in which the small-sized wire saw device performs cutting in accordance with an embodiment of the present invention.

FIG. 5 is a view showing a figure in which an additional frame is connected to the main frame in accordance with an embodiment of the present invention.

### BEST MODE

The invention is described in detail below with reference to the accompanying drawings illustrating specific embodiments that can be practiced. These embodiments are described in sufficient detail to enable those skilled in the art to practice the invention. The various embodiments of the invention are not mutually exclusive, although they are different from one another. For example, particular shape, structure, and characteristic described in one embodiment may be implemented in other embodiments without departing from the spirit and scope of the invention. It is to be understood that the location or arrangement of individual elements within each disclosed embodiment may be modified without departing from the spirit and scope of the invention. Accordingly, the following detailed description not intended to be limitative, and the scope of the invention is defined by the appended claims and their equivalents. Like reference numerals in the drawings denote the same or similar functions in all respects.

Hereinafter, preferred embodiments of the present invention will be described in detail with reference to the accompanying drawings in order to enable those skilled in the art to easily implement the present invention.

First, for convenience of description, the following description will be given, assuming that an object to be cut (for example, concrete, rock, etc.) is disposed in front of a small-sized wire saw device. Here, “front” is a concept including surroundings around a front portion of the small-sized wire saw device, and need not mean a central region in front of the small-sized wire saw device.

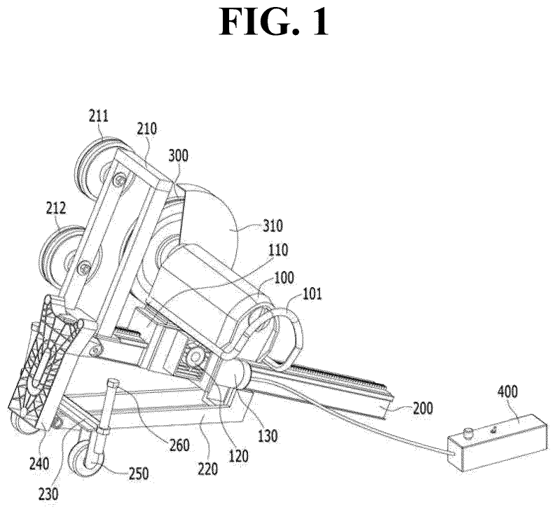

FIG. 1 is a view showing a configuration of a small-sized wire saw device according to an embodiment of the present invention.

The small-sized wire saw device may be constituted by a power unit 10 configured to generate power, etc., a stand 20 configured to form a support structure, a main wheel 300, etc.

First, the stand 20 may be constituted by a main frame 200 having a bar shape elongated forwards and rearwards, an outer frame 240 disposed at a front portion of the main frame 200, and a connection frame 220 configured to interconnect the main frame 200 and the outer frame 240.

Assuming that an object to be cut is disposed at a front side with reference to the small-sized wire saw device, the main frame 200 has a bar shape elongated in a longitudinal direction toward a front side and a rear side. The main frame 200, which will be described later, may be provided, at an upper end thereof, with a central rail 201 extending in the longitudinal direction, and upper grooves 202 may be formed at opposite sides of the central rail 201 to extend in the longitudinal direction.

The outer frame 240 may be connected, at one side thereof, to the front portion of the main frame 200, and may be disposed at a lower end of the front portion of the main frame 100. As can be seen from FIG. 1, the outer frame 240 may be disposed at a position nearest to the object to be cut. Connection portions of the main frame 200 and the outer frame 240 may be interconnected through various methods, for example, hinge coupling, thread coupling, etc. The main frame 200 and the outer frame 240 may be perpendicular to each other.

Next, one side of the connection frame 220 may be connected to the other side of the outer frame 240 (a side opposite to the side connected to the main frame 200) (through various coupling methods, for example, hinge coupling, thread coupling, etc.), and the other side of the connection frame 220 may be connected to a lower end of the main frame 200 at a central portion of the main frame 200. A connector, which interconnects the other side of the connection frame 220 and the main frame 200, may move forwards in the longitudinal direction or downwards along the lower end of the main frame 200. That is, as the connector between the connection frame 220 and the main frame 200 moves, the form of the stand 20 may be varied.

For reference, the connector between the connection frame 220 and the main frame 200 may be constituted by an engagement lug and an engagement jaw. An engagement lug attached to an end of the connection frame 220 may be engaged with one of a plurality of engagement jaws respectively provided at the lower end of the main frame 200 at different positions. That is, the position of the connector between the connection frame 220 and the main frame 200 may be varied in accordance with which one of the engagement jaws is engaged with the engagement lug.

The main frame 200, the outer frame 240, and the connection frame 220 may form a triangular structure. When the main frame 200 and the outer frame 240 are in a state of being perpendicular to each other, a right triangular structure may be formed.

The stand 20 may further include a vertical frame 210 and a bottom frame 230. The vertical frame 210 may be disposed at an upper end of the front portion of the main frame 200. As described above, the outer frame 240 may be disposed at the lower end of the front portion of the main frame 200.

The vertical frame 210 may also be formed perpendicular to the main frame 200, and the vertical frame 210 and the outer frame 240 may be parallel to each other. For reference, the connection portions of the main frame 200 and the outer frame 240 may be disposed in front of connection portions of the main frame 200 and the vertical frame 210 on the front portion of the main frame 200. That is, the outer frame 240 may be installed at a position nearer to the object to be cut than the vertical frame 210.

As can be seen from FIG. 1, the connection frame 220 is disposed such that front and rear sides thereof extend in a longitudinal direction. In addition, the main frame 200 is disposed such that front and rear sides thereof extend in a longitudinal direction. However, each of the main frame 200 and the connection frame 220 may have a structure in which front and rear sides thereof extend in the longitudinal direction while having a predetermined inclination. For example, each of the main frame 200 and the connection frame 220 may form a predetermined angle (for example, 20°, etc.) with respect to a floor surface.

The bottom frame 230 is installed at an upper end of the front side of the connection frame 220. The bottom frame 230 is disposed to be perpendicular to a direction in which the front and rear sides of the connection frame 220 extend. The bottom frame 230 includes auxiliary wheels 250 at opposite ends thereof, respectively. The auxiliary wheels 250 support movement of the small-sized wire saw device. As the auxiliary wheels 250 rotate in a state in which a rear end of the main frame 200 is lifted, the small-sized wire saw device may be moved.

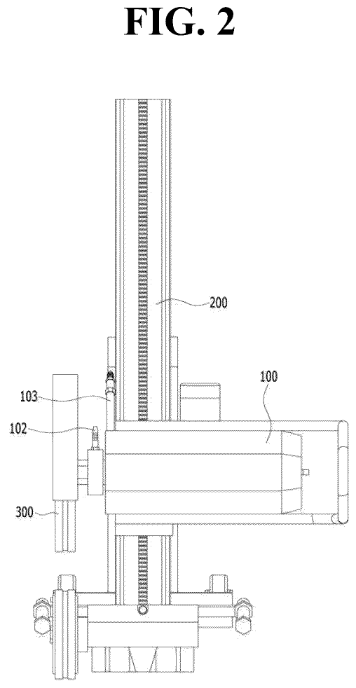

The small-sized wire saw device includes the power unit 10 configured to generate power, etc., and this will be described later with reference to FIG. 2.

FIG. 2 is a view showing a configuration of the power unit and the wheel according to an embodiment of the present invention.

The power unit 10 may include a slider 110 configured to move forwards or downwards on the main frame 200, a first motor 100 attached to one end (for example, an upper end) of the slider 110, a second motor 130 configured to support movement of the slider 110, a reducer 120 disposed between the second motor 130 and the slider 110, etc.

In detail, the slider 110 is disposed at the upper end of the main frame 200, the first motor 100 may be disposed at the upper end of the slider 110, and the reducer 120 and the second motor 130 may be disposed at a side surface of the slider 110. In addition, a handle 101 is disposed at one side of the first motor 100 to support a task of the operator.

When the first motor 100 and the slider 110 are directly interconnected without the reducer 120, the movement distance of the slider 110 may become beyond the length of the main frame 200 by power generated by the first motor 100. In addition, the reducer 120 may be needed for manipulation for more precise movement.

The first motor 100 may be an electric motor, a hydraulic motor, or a pneumatic motor (or an air-powered motor). The pneumatic motor is an appliance configured to perform rotation using air in place of electricity. The pneumatic motor uses a system in which vanes (blades) rotate a shaft of the motor using force of air. The pneumatic motor may be applied to a facility where use of electricity is not possible or equipped with only air lines, an hazardous area, etc. Since no electricity is used, there is no danger of explosion. In association with a small-sized appliance, it is preferred that the first motor 100 be a pneumatic motor in that the pneumatic motor does not require a coolant, is suitable for a facility in which only air lines are present, and is 5 or more times stronger than an electric motor. In this regard, in the small-sized wire saw device according to the present invention, it is preferred that the first motor 100 be a pneumatic motor.

On the other hand, when the first motor 100 is an electric motor, the first motor 100 may be driven at 220V. Although a general wire saw device is driven at 330V, the wire saw device of the present invention may be driven at 220V because the wire saw device of the present invention has a small-sized structure.

In addition, when the first motor 100 rotates the main wheel 300 attached to one side surface thereof while operating as an electric motor, heat may be generated. Accordingly, a procedure of dissipating the heat is required and, as such, a coolant may be used. That is the first motor 100 corresponds to a motor configured to be driven by electricity while being cooled by a coolant.

Referring to FIG. 2, a first hose 103 is connected to the first motor 100, and a coolant is sucked through the first hose 103 and, as such, is introduced into an interior of the first motor 100. The coolant disposed in the interior of the first motor 100 dissipates heat generated from the first motor 100, and may then be discharged outwards through a second hose 102 disposed between the first motor 100 and the main wheel 300 after dissipating the heat.

For reference, as can be seen from FIG. 2, the first motor 100 and the main wheel 300 are interconnected through a connection column and, as such, rotation force generated from the first motor 100 is transmitted to the main wheel 300, thereby rotating the main wheel 300. In this case, a predetermined gap may be present between the first motor 100 and the main wheel 300.

In this case, the second hose 102 may be present in the predetermined gap. The second hose 102 may rotate 360° on the connection column and, as such, may be directed toward a front side, a rear side, an upper side, or a lower side. That is, it may be possible to adjust a discharge direction of the coolant dissipating heat. Accordingly, it may be possible to treat the coolant without causing interference with a procedure of cutting an object to be cut (for example, concrete, etc.) which is disposed at a front side.

In addition, the first hose 103 may also rotate 360° while being disposed on the connection column between the first motor 100 and the main wheel 300. If necessary, the first hose 103 may be directly connected to the first motor 100.

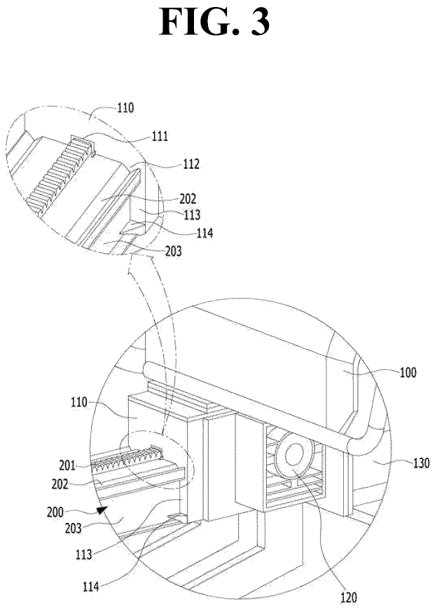

FIG. 3 is a view showing a connection structure between the main frame and the power unit according to an embodiment of the present invention. The slider 110 has a structure surrounding an upper end of the main frame 200, and this will be described in detail with reference to FIG. 3.

The central rail 201 and the upper grooves 202 disposed at the opposite sides of the central rail 201 may be present at the upper end of the main frame 200. In this case, the central rail 201 takes the form of teeth arranged in the longitudinal direction of the main frame 200, and the upper grooves 202 may take the form of valleys extending in the longitudinal direction of the main frame 200 at opposite sides of the main frame 200, respectively.

The teeth-shaped central rail 201 is inserted into a central groove 111, which is disposed at an upper end of an inner portion of the slider 110, to engage with the central groove 111, and, as such, a position of the slider 110 may be locked. In addition, small protrusions 112 are present on the upper end of the inner portion of the slider 110 at opposite sides of the central groove 111, respectively. The small protrusions 112 may be inserted into the upper grooves 202, respectively.

In addition, side grooves 203 extending in a longitudinal direction may be present at opposite side surfaces of the main frame 200, respectively, and large protrusions 113 disposed at opposite sides of the inner portion of the slider 110 may be inserted into the side grooves 203, respectively. The slider 110 may slide on the main frame 200 in a state in which the large protrusions 113 at the opposite sides of the inner portion of the slider 110 are inserted into the side grooves 203 at the opposite sides of the main frame 200, respectively. In particular, sharp supports 114 are provided at respective lower ends of the large protrusions 113 and, as such, it may be possible to lock the slider 110 while preventing lateral movement of the slider 110 when the slider 110 moves on the main frame 200.

As can be seen from FIG. 3, the upper end of the main frame 200 may have a greater width than those of other portions of the main frame 200 because the side grooves 203 are present at the opposite side surfaces of the main frame 200. In addition, an outer portion of the slider 110 may have a flat structure in order to enable attachment of the first motor 100, the reducer 120, etc. thereto, but the inner portion of the slider 110 may include the central groove 111, the small protrusions 112, etc. while having a downwardly-opened space. Thus, the slider 110 has a structure surrounding the upper end of the main frame 200 in the inner space thereof.

Meanwhile, the main wheel 300, which is connected to the first motor 100, is present at one side surface of the slider 110. The slider 110 may include a reducer 120 and a second motor 130 disposed at a side surface thereof opposite to the one side surface. For reference, the reducer 120 and the second motor 130 may be disposed under the first motor 100.

The second motor 130 may generate power, thereby supporting forward or rearward movement of the slider 110. Of course, the reducer 120 is needed for more correct and precise movement of the slider 110. Accordingly, power generated from the second motor 130 may be transmitted to the slider 110 via the reducer 120.

For reference, the reducer 120 may be connected to the slider 110 through direct attachment thereof to the slider 110, and the second motor 130 may be connected to the reducer 120 through direct attachment thereof to the reducer 120. Although the second motor 130 is not directly connected to the slider 110, the second motor 130 may be attached to the slider 110.

The second motor 130 may be an electric motor, and, if necessary, may be a hydraulic motor. The second motor 130 may operate by a controller 400 connected thereto and, as such, the controller 400 may control movement of the slider 110.

In detail, the controller 400 may include a first manipulator configured to control forward movement or rearward movement of the slider 110, and a second manipulator configured to control a speed of the slider 110. That is, the operator may control forward movement or rearward movement of the slider 110 using the first manipulator, and may control a speed of the slider 110 using the second manipulator, thereby achieving more precise manipulation. Here, each of the first manipulator and the second manipulator may correspond to a controller having various input systems such as a button type input system, a joystick type input system, etc.

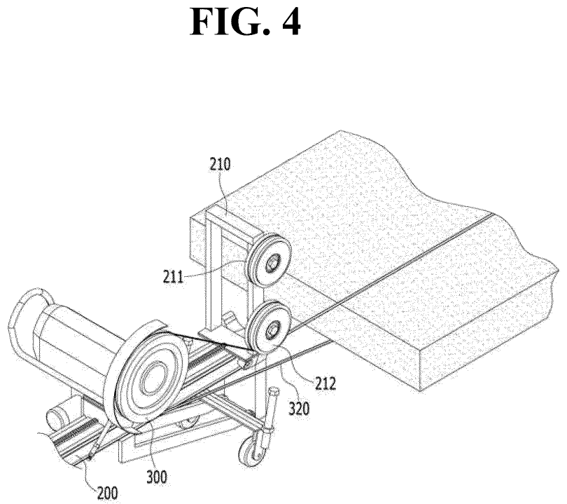

FIG. 4 is a view showing a figure in which the small-sized wire saw device performs cutting in accordance with an embodiment of the present invention.

As can be seen from FIG. 4, in the small-sized wire saw device of the present invention, a wire 320 wound around the main wheel 300 may cut concrete, rock, etc. In detail, the wire 320 configured to rotate together with the main wheel 300 may contact an upper auxiliary wheel 211 or a lower auxiliary wheel 212 attached to one side surface of the vertical frame 210 and, as such, rotate together therewith.

That is, an upper end portion of the wire 320 wound around the main wheel 300 may contact a lower end of the lower auxiliary wheel 212 and, as such, may rotate together therewith, as shown in FIG. 4, whereas the wire 320 may contact the upper auxiliary wheel 211 and, as such, may rotate together therewith, differently from the case of FIG. 4. This may be determined with reference to a height of the object to be cut, a distance from the object to be cut, etc.

In the above-described case, a lower end portion of the wire 320 may contact the bottom frame 230. In this case, the wire 320 may be guided by guide poles 260 disposed at opposite sides of the bottom frame 230 such that the wire 320 does not escape from the bottom frame 230.

In addition, each guide pole 260 has a large-diameter bolt structure and, as such, may move upwards and downwards in accordance with clockwise or counterclockwise rotation thereof. That is, horizontality of the small-sized wire saw device may be adjusted by the guide poles 260.

In detail, when the small-sized wire saw device performs a task, the small-sized wire saw device should be fixed at a particular position. In this case, accordingly, movement of the small-sized wire saw device by the auxiliary wheels 250 should be prevented. To this end, the guide poles 260 present at opposite sides of the auxiliary wheels 250 may move downwards in accordance with rotation thereof and, as such, may levitate the auxiliary wheels 250. As the opposite guide poles 260 move downwards, the small-sized wire saw device may be fixed and, as such, it may be possible to prevent a slippage of the small-sized wire saw device caused by rotation of the auxiliary wheels 250 during execution of a task.

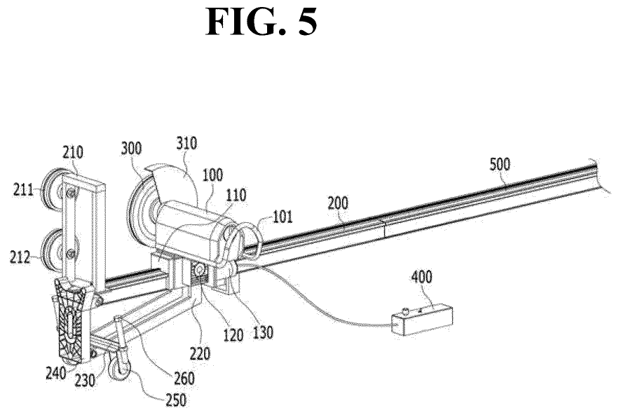

FIG. 5 is a view showing a figure in which an additional frame is connected to the main frame in accordance with an embodiment of the present invention.

The small-sized wire saw device of the present invention may provide convenience of manipulation to the operator, and as an extension thereof, in the present invention, an additional frame 500 may be connected to a rear portion of the main frame 200 in order to enable the slider 110 to move forwards or downwards on the main frame 200 and the additional frame 500.

In detail, when the main frame 200 and the additional frame 500 are interconnected to enable the slider 110 to move on the two frames, the operator may easily adjust a cutting angle and a length of the wire 320 and, as such, more precise cutting may be achieved.

Meanwhile, a cover 310 may be attached to the main wheel 300 to prevent the wire 320 from being separated from the main wheel 300 during rotation thereof. In addition, the cover 310 may protect the operator for safety, and may guide water used during execution of a task to flow downwards without splashing in all directions. For reference, the wire saw device needs water during execution of a cutting task.

The above-described embodiments of the cutter are intended only for illustration, and it will be understood by those skilled in the art that the present invention may be easily modified in other specific forms without changing the technical spirit or essential features of the present invention. Therefore, it should be understood that the embodiments described above are exemplary in all respects and not restrictive. For example, each constituent element described as a single type may be implemented in a distributed manner, and similarly, constituent elements described as being distributed may be implemented in a combined form.

The scope of the present invention is shown by the following claims rather than the detailed description, and all changes or modifications derived from the meaning and scope of the claims and their equivalents should be construed as being included in the scope of the present invention.

[Description of Reference Numerals]

100: first motor, 101: handle, 102: second hose,
103: first hose
110: slider, 111: central groove, 112: small
protrusion, 113: large protrusion, 114: support
120: reducer, 130: second motor
200: main frame
210: vertical frame, 211: upper auxiliary wheel,
212: lower auxiliary wheel
220: connection frame, 230: bottom frame, 240:
outer frame, 250: auxiliary wheel
260: guide pole
300: main wheel, 310: cover, 320: wire, 400:
controller, 500 additional frame

### INDUSTRIAL APPLICABILITY

The small-sized wire saw device according to the present invention is industrially applicable to cutting of a concrete structure, rocks, etc. on construction sites.

1. A small-sized wire saw device comprising:
a stand comprising a main frame having a bar shape elongated forwards and rearwards in a state in which an object to be cut is disposed in front of the small-sized wire saw device, an outer frame disposed at a front portion of the main frame, and a connection frame configured to interconnect the main frame and the outer frame;
a slider configured to move forwards or downwards on the main frame;
a power unit comprising a first motor attached to an upper end of the slider;
a main wheel attached to one side surface of the power unit and configured to be rotated by the first motor; and
a second motor disposed at another side surface of the power unit and configured to support movement of the slider.

2. The small-sized wire saw device according to claim 1, further comprising:
a reducer disposed at the other surface of the power unit between the second motor and the slider and configured to transmit power generated from the second motor to the slider.

3. The small-sized wire saw device according to claim 1, wherein the first motor comprises a pneumatic motor.

4. The small-sized wire saw device according to claim 1, further comprising:
a first hose connected to the first motor and configured to supply a coolant to the first motor, when the first motor is an electric motor; and
a second hose disposed between the first motor and the main wheel and configured to outwardly discharge the supplied coolant.

5. The small-sized wire saw device according to claim 1, wherein the slider comprises a central groove having a structure corresponding to a structure of a central rail, first protrusions each having a structure corresponding to a structure of upper grooves, and second protrusions each having a protruding structure corresponding to a structure of side grooves.

6. The small-sized wire saw device according to claim 1, wherein the main frame comprises:
a central rail formed at an upper end of the main frame to have a protruding structure;
upper grooves respectively formed in a longitudinal direction at opposite sides of the central rail to have an engraved structure; and
side grooves respectively formed in the longitudinal direction at opposite side surfaces of the main frame to have an engraved structure.

7. The small-sized wire saw device according to claim 1, further comprising:
a controller connected to the second motor,
wherein the controller comprises a first manipulator configured to control forward movement or rearward movement of the slider, and a second manipulator configured to control a speed of the slider.

8. The small-sized wire saw device according to claim 1, wherein:
a vertical frame is provided at an upper end of the front portion of the main frame, and the outer frame is provided at a lower end of the front portion of the main frame; and
an upper auxiliary wheel or a lower auxiliary wheel is provided at one side surface of the vertical frame, and a wire configured to be driven by the main wheel contacts the upper auxiliary wheel or the lower auxiliary wheel so as to be rotated.

9. The small-sized wire saw device according to claim 1, further comprising:
a bottom frame installed at an upper end of the connection frame; and
auxiliary wheels respectively attached to opposite ends of the bottom frame.

10. The small-sized wire saw device according to claim 1, further comprising:
an additional frame connected to a rear portion of the main frame,
wherein the slider is configured to move forwards or downwards on the main frame and the additional frame.
